(19) United States
(12) Patent Application Publication
(10) Pub. No.: US 2026/0138147 A1
(43) Pub. Date: May 21, 2026

(54) Supply Device for Supplying Coating Medium, Coating Medium Apparatus, System and Method of Supplying Coating Medium

(71) Applicant: ABB Schweiz AG, Baden (CH)

(72) Inventors: Jose Rodrigues, Bad Homburg Hesse (DE); Ole-Morten Larsen, Sandnes (NO); Geir Krogedal, Sandnes (NO); Einar Aasland, Bryne (NO); Jakob Trydal, Kvernaland (NO)

(21) Appl. No.: 18/704,132

(22) PCT Filed: Nov. 2, 2021
(86) PCT No.: PCT/EP2021/080367

§ 371 Date: Apr. 24, 2024

(51) Int. Cl. B05B 13/04; B05B 12/14; B05B 15/55

(52) U.S. Cl. CPC B05B 13/0433; B05B 15/55; B05B 12/14

(57) ABSTRACT

A supply device for supplying coating medium to a tank, the supply device including a docking element; a plurality of supply lines; and a switching device having a connection member to which each supply line is connected, the switching device being configured to move the connection member or the docking element in order to connect a selected supply line to the docking element for supply of coating medium from the selected supply line through the docking element. A coating medium apparatus for applying coating medium to an object, a system including a supply device, and a method of supplying coating medium to a tank

### TECHNICAL FIELD

The present disclosure generally relates to handling of coating mediums for applications where coating mediums are applied to an object. In particular, a supply device for supplying coating medium to a tank, a coating medium apparatus for applying coating medium to an object, a system comprising a supply device, and a method of supplying coating medium to a tank, are provided.

### BACKGROUND

In robotized automotive painting, the paint is usually electrically charged inside an atomizer, to increase the transfer efficiency between the atomizer and a car body. Waterborne paint is electrically conductive. As a result, a paint supply line external to an industrial robot carrying the atomizer must be electrically isolated from the paint inside the atomizer before a high voltage can be applied to the paint in the atomizer.

Electric isolation is typically achieved by filling a tank with paint before starting a painting cycle. When the tank has been filled from the supply line, the tank is disconnected from the supply line and becomes electrically isolated therefrom. The tank may be integrated in the atomizer, or may be provided in a cartridge that in turn is docked to the atomizer.

Before each painting cycle, the tank must be refilled with paint. The supply line is typically connected to a color changer. When refilling the tank with a new color, the color changer is filled with this color. The color changer needs to be cleaned before supplying the new color. A significant amount of paint is therefore wasted. The paint inside the color changer plus the paint inside the paint supply line and the tank must be flushed out before the new color can be loaded.

EP 0851128 A2 discloses a system for transfer of fluids. The system comprises a spraying device having a canister. The spraying device is carried by a robot. The system further comprises a paint drop cluster having a plurality of paint drops.

### SUMMARY

One object of the present disclosure is to provide an improved supply device for supplying a coating medium to a tank.

A further object of the present disclosure is to provide a supply device for supplying a coating medium to a tank, which supply device reduces waste of coating medium.

A further object of the present disclosure is to provide a supply device for supplying a coating medium to a tank, which supply device reduces waste of coating medium for a high number of different coating mediums.

A still further object of the present disclosure is to provide a supply device for supplying a coating medium to a tank, which supply device has a compact design.

A still further object of the present disclosure is to provide a supply device for supplying a coating medium to a tank, which supply device has a cost-efficient design.

A still further object of the present disclosure is to provide a supply device for supplying a coating medium to a tank, which supply device enables a fast supply of coating medium.

A still further object of the present disclosure is to provide a supply device for supplying a coating medium to a tank, which supply device enables a reduced downtime between painting operations.

A still further object of the present disclosure is to provide a supply device for supplying a coating medium to a tank, which supply device solves several or all of the foregoing objects in combination.

A still further object of the present disclosure is to provide a coating medium apparatus solving one, several or all of the foregoing objects.

A still further object of the present disclosure is to provide a coating medium apparatus enabling an accurate filling of a tank.

A still further object of the present disclosure is to provide a system solving one, several or all of the foregoing objects.

A still further object of the present disclosure is to provide a method of supplying coating medium to a tank, which method solves one, several or all of the foregoing objects.

According to a first aspect, there is provided a supply device for supplying coating medium to a tank, the supply device comprising a docking element; a plurality of supply lines; and a switching device having a connection member to which each supply line is connected, the switching device being configured to move the connection member or the docking element in order to connect a selected supply line to the docking element for supply of coating medium from the selected supply line through the docking element.

The supply device enables the tank to be filled practically directly from the selected supply line. Since the docking element may only contain a very small volume for passing the coating medium therethrough, the waste of coating medium can be reduced to an absolute minimum.

Each supply line may run from a factory supply line to the docking element, resulting in an extremely low paint waste. The supply device also gives the same minimum waste of coating medium for each type of coating medium, and not only for the most often used coating mediums.

The tank may be a tank of a coating medium apparatus. The coating medium apparatus may be configured to apply coating medium to an object. Such coating medium apparatus may for example be an atomizer.

Alternatively, or in addition, such coating medium apparatus may be configured to electrically charge the coating medium.

The switching device may be configured to move the connection member relative to the docking element. In this case, the docking element may be stationary during movement of the connection member. The provision of only one docking element and a movable connection member enables an industrial robot carrying the coating medium apparatus to be moved to the same position each time for filling, regardless of which type of coating medium that should be filled. This in turn greatly facilitates programming and calibration of the industrial robot.

Alternatively, the switching device may be configured to move the docking element relative to the connection member. In this case, the connection member may be stationary during movement of the docking element.

When the industrial robot carrying the coating medium apparatus performs a coating task, the connection member or the docking element may be moved such that a next supply line becomes aligned with the docking element. In case the connection member is moved such that the next supply line becomes aligned with the docking element, the docking element may optionally be moved away from the connection member to disconnect the docking element prior to moving the connection member. After alignment of the next supply line, the docking element may then be moved back towards the connection member to connect the docking element to the next supply line. To these ends, the supply device may comprise a docking support movable relative to the connection member, and the docking element may be fixed to the docking support. Alternatively, the docking element may be connected with the next supply line only by movement of the connection member by the switching device. In any case, the next coating medium can be prepared without causing any downtime of the coating task.

The provision of only one docking element further enables a conventional color changer to be eliminated. Such conventional color changer typically comprises a plurality of valves and a manifold.

Moreover, the provision of only one docking element and a movable connection member enables a more efficient cleaning of an exterior body of the coating medium apparatus when the coating medium apparatus is connected to the docking element. This in turn reduces a total cycle time.

Furthermore, due to the provision of only one docking element, the supply device has a compact and cost-efficient design.

The docking element may have a thickness of less than 50 mm, such as less than 30 mm. Due to this small thickness, the flow area inside the docking element can be made slightly larger to thereby significantly increase the flow of coating medium without significantly increasing waste of coating medium. A larger flow area also reduces pressure losses. The flow areas inside the supply lines can be also be enlarged in a corresponding way.

An end of each supply line may be fixed to the connection member. The supply device may comprise at least five supply lines, such as at least ten supply lines, such as at least 20 supply lines, connected to the connection member. The supply device thus enables low waste also of coating mediums that are less frequently used. In this way, the need for a booster between the supply lines and the tank can be eliminated, although the supply device can optionally be used to fill a cartridge containing the tank. Throughout the present disclosure, the supply lines may be parallel.

The switching device may comprise a switching actuator, such as an electric switching motor, arranged to move the connection member. In case a docking support is used, the supply device may comprise a docking actuator, such as a pneumatic cylinder or an electric motor, arranged to move the docking support.

Throughout the present disclosure, the coating medium may be paint, such as waterborne paint. One example of an alternative coating medium is varnish.

As a possible variant, the coating medium apparatus may comprise, or be constituted by, a cartridge. An atomizer may for example comprise a detachable cartridge containing the tank.

The connection member may be rotatable in order to connect the selected supply line to the docking element. The connection member may be rotatable about a rotation axis. Each supply line may be positioned at the same radial distance from the rotation axis. The connection member may be a rotatable disc. A rotatable connection member contributes to a more compact design. As a possible alternative, the connection member may be linearly movable.

The docking element may comprise an internal port to which each supply line can be selectively connected, and an external port to which an inlet of a coating medium apparatus can be connected. In this case, the docking element may be configured to conduct coating medium from the internal port to the external port. A distance between the internal port and the external port may correspond to the width of the docking element.

The docking element may further comprise a docking line from the internal port to the external port. The docking line may be substantially straight, or straight. The internal port and the external port may provide the only flow interfaces of the docking line for coating medium to the tank.

The supply device may further comprise a cleaning device arranged to clean an exterior body of a coating medium apparatus comprising the tank while the coating medium apparatus is connected to the docking element. By cleaning the body while the coating medium apparatus is connected to the docking element, the cycle time is reduced.

The cleaning device may comprise a container arranged to at least partly receive the body and to supply cleaning medium onto the body. The container may sealingly receive the body. The container may further be arranged to supply pressurized air onto the body for drying the body. Throughout the present disclosure, the cleaning medium may be solvent.

The supply device may be configured to move the container relative to the docking element between a releasing position where the body is cleared form the container, and a cleaning position where the body is at least partly received in the container, while the coating medium apparatus is connected to the docking element. Thus, instead of moving the coating medium apparatus into the container, the container moves relative to the stationary coating medium apparatus. In this way, cleaning of the coating medium apparatus can be performed simultaneously with the filling of the tank. The container may supply pressurized air onto the body, for example while moving from the cleaning position towards the releasing position.

The container may be linearly movable between the releasing position and the cleaning position. A purely linear movement of the container is enabled due to the provision of a single docking element and a movable connection member, which implies that the coating medium apparatus is moved to the same position for each filling, regardless of which coating medium to be filled. The provision of only one docking element also enables use of only one container for cleaning.

According to a second aspect, there is provided a coating medium apparatus for applying coating medium to an object, the coating medium apparatus comprising an inlet for receiving coating medium; a tank having a tank volume for receiving coating medium from the inlet; a piston movable relative to the tank to vary the tank volume; and a servomotor configured to control movements of the piston based on a position of the piston.

During filling of the tank, the amount of coating medium to be filled is controlled by the servomotor. The use of the servomotor gives a very precise filling of the tank. The precise filling also contributes to a reduced waste of coating medium. If the tank is overfilled and not all the coating medium is consumed during the application cycle, the amount remaining in the tank will be wasted at the next change of coating mediums.

The coating medium apparatus may comprise an encoder configured to provide a position signal indicative of a position of the piston. The position signal may be contain a value of an absolute position of an output shaft of the servomotor. The servomotor may be configured to control movements of the piston based on the position signal.

The coating medium apparatus may further comprise a transmission between the servomotor and the piston. The transmission may comprise a belt and/or a translation mechanism. The translation mechanism may be configured to transmit a rotational movement generated by the servomotor to a linear movement of the piston. The translation mechanism may be telescopic. The translation mechanism may for example comprise a translation screw.

The coating medium apparatus may further comprise an outlet for applying coating medium to the object. In this case, the tank may be arranged to supply coating medium to the outlet.

The servomotor may be configured to control movements of the piston based on a pressure of the coating medium. To this end, a pressure sensor may be used to provide a pressure signal indicative of the pressure of the coating medium. The pressure sensor may for example be positioned in the docking element.

The servomotor may be arranged to withstand a pressure of the coating medium of at least 2 bar, such as at least 10 bar.

According to a third aspect, there is provided a system comprising the supply device according to the first aspect and a coating medium apparatus having an inlet configured to be connected to the docking element. The coating medium apparatus may further comprise a tank for containing the coating medium. The tank may be integrated in the coating medium apparatus or may be detachably attached to the coating medium apparatus.

The coating medium apparatus in the third aspect may be of any type according to the present disclosure, for example according to the second aspect. The system may further comprise an industrial robot carrying the coating medium apparatus. The industrial robot may comprise a manipulator movable in three or more axes, such as in six or seven axes.

According to a fourth aspect, there is provided a method of supplying coating medium to a tank, the method comprising providing a supply device comprising a docking element, a plurality of supply lines, and a switching device having a connection member to which each supply line is connected; providing a coating medium apparatus comprising an inlet and the tank; connecting the inlet to the docking element and receiving a first coating medium in the tank from a first supply line through the docking element; disconnecting the inlet from the docking element; and moving the connection member or the docking element in order to connect a second supply line to the docking element.

The supply device and the coating medium apparatus may be of any types according to the present disclosure. The method may further comprise connecting the inlet to the docking element and receiving a second coating medium in the tank from the second supply line through the docking element. Alternatively, the method may further comprise connecting an inlet of a further coating medium apparatus to the docking element and receiving the second coating medium in a tank of the further coating medium apparatus from the second supply line through the docking element.

The method may further comprise providing a cleaning device; and cleaning an exterior body of the coating medium apparatus by means of the cleaning device while the inlet is connected to the docking element. The cleaning device may be of any type according to the present disclosure.

The cleaning device may comprise a container. In this case, the cleaning may comprise moving the container relative to the body such that the body is at least partly received in the container; and supplying cleaning medium onto the body.

### BRIEF DESCRIPTION OF THE DRAWINGS

Further details, advantages and aspects of the present disclosure will become apparent from the following description taken in conjunction with the drawings, wherein:

FIG. 1: schematically represents a side view of a system comprising an industrial robot, a coating medium apparatus and a supply device;

FIG. 2: schematically represents a perspective side view of the coating medium apparatus;

FIG. 3: schematically represents a perspective front view of the supply device;

FIG. 4: schematically represents a block diagram of components of the coating medium apparatus and the supply device;

FIG. 5: schematically represents a perspective front view of the supply device and the coating medium apparatus;

FIG. 6: schematically represents a perspective front view of the supply device and the coating medium apparatus when a container has moved to a cleaning position;

FIG. 7: schematically represents a perspective view of components of the coating medium apparatus; and

FIG. 8: schematically represents a side view of a further example of a coating medium apparatus.

### DETAILED DESCRIPTION

In the following, a supply device for supplying coating medium to a tank, a coating medium apparatus for applying coating medium to an object, a system comprising a supply device, and a method of supplying coating medium to a tank, will be described. The same or similar reference numerals will be used to denote the same or similar structural features.

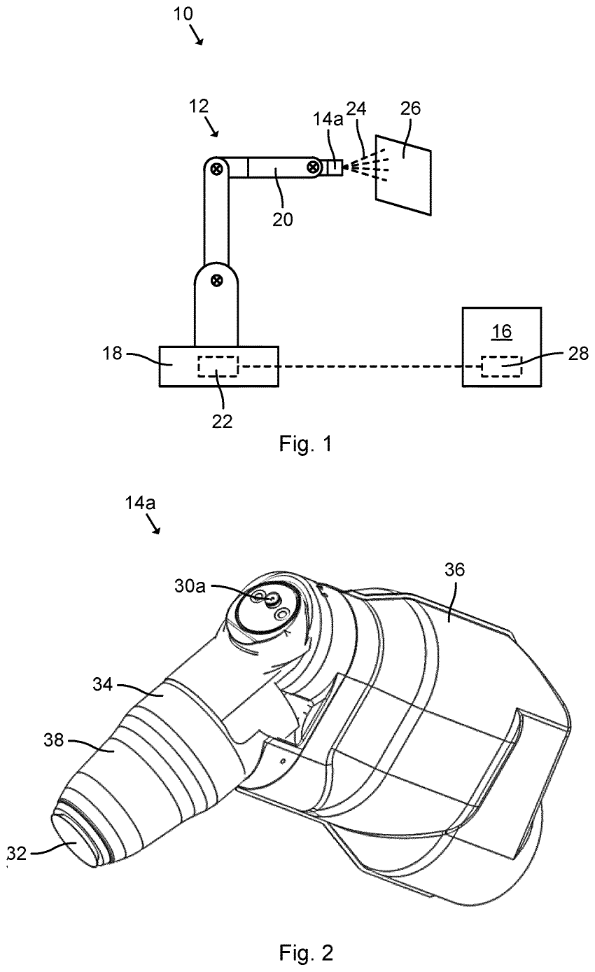

FIG. 1 schematically represents a side view of a system 10. The system 10 comprises an industrial robot 12, a coating medium apparatus, here exemplified as an atomizer 14a, and a supply device 16.

The industrial robot 12 of this example comprises a base 18 and a manipulator 20 movable relative to the base 18. The manipulator 20 of this specific example comprises six degrees of freedom. The atomizer 14a is carried by the manipulator 20, here at a distal end thereof.

The industrial robot 12 further comprises an electric robot control system 22. In this example, the robot control system 22 is configured to control operations of the industrial robot 12 and the atomizer 14a. To this end, the robot control system 22 is in signal communication with the manipulator 20 and the atomizer 14a. The robot control system 22 comprises at least one data processing device and at least one memory having at least one computer program stored thereon. The at least one computer program comprises program code which, when executed by the at least one data processing device, causes the at least one data processing device to perform, or command performance of, various steps as described herein.

As shown in FIG. 1, the atomizer 14a can apply paint 24 onto an object 26. The paint 24 is one example of a coating medium according to the present disclosure. The paint 24 is here waterborne paint. In this example, the atomizer 14a is configured to apply paint 24 to the object 26 by means of electrostatic coating. The object 26 may for example be a vehicle body.

The supply device 16 is configured to supply paint 24 to the atomizer 14a between painting operations. The supply device 16 comprises an electric supply control system 28. The supply control system 28 is configured to control operations of the supply device 16. The supply control system 28 comprises at least one data processing device and at least one memory having at least one computer program stored thereon. The at least one computer program comprises program code which, when executed by the at least one data processing device, causes the at least one data processing device to perform, or command performance of, various steps as described herein.

FIG. 2 schematically represents a perspective side view of one example of the atomizer 14a. The atomizer 14a comprises an inlet 30a. The atomizer 14a is configured to receive paint 24 from the supply device 16 through the inlet 30a.

The atomizer 14a further comprises an outlet 32. The atomizer 14a is configured to apply paint 24 through the outlet 32. As shown in FIG. 2, the outlet 32 comprises a rotatable bell cup for atomizing the paint 24.

The atomizer 14a further comprises an external body 34. The body 34 of this example comprises a proximal section 36 and a distal section 38. The distal section 38 is angled relative to the proximal section 36, here approximately 60 degrees. The inlet 30a is here positioned at a transition between the proximal section 36 and the distal section 38. The outlet 32 is positioned at a distal end of the distal section 38. The inlet 30a is here angled 90 degrees to the bell cup.

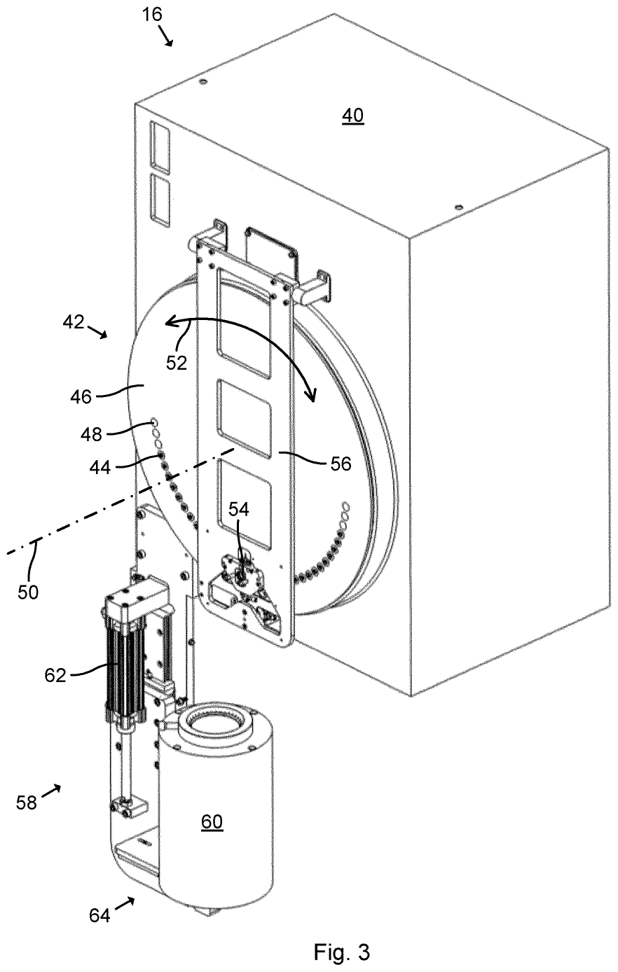

FIG. 3 schematically represents a perspective front view of the supply device 16. The supply device 16 of this example comprises a base structure 40, a switching device 42 and a plurality of parallel supply lines 44. The base structure 40 is here exemplified as a housing. The switching device 42 of this example comprises a rotatable disc 46. The rotatable disc 46 is one example of a connection member according to the present disclosure. The rotatable disc 46 of this example comprises a plurality of through holes 48.

As shown in FIG. 3, an end of each supply line 44 is fixed to the rotatable disc 46 in a unique through hole 48 thereof. Each supply line 44 contains paint 24 of a unique color. The rotatable disc 46 of this specific example comprises 36 through holes 48 and can consequently be used with up to 36 unique supply lines 44. Moreover, in this specific and non-limiting example, the supply device 16 comprises 30 supply lines 44 (six through holes 48 are vacant). The supply device 16 of this specific example can thus supply paint 24 of 30 unique colors.

The supply device 16 is configured to rotate the rotatable disc 46 about a rotation axis 50, as shown with arrow 52. To this end, the supply device 16 comprises a switching actuator (not shown) for rotating the rotatable disc 46. As shown in FIG. 3, the radial distances between the rotation axis 50 and each supply line 44 are equal for all supply lines 44.

The supply device 16 further comprises a docking element 54. The atomizer 14a can dock to the supply device 16 such that the inlet 30a is connected to the docking element 54. By rotating the rotatable disc 46, a supply line 44 containing a desired color can selectively be brought into connection with the docking element 54. In this way, the selected paint 24 can be supplied from the supply line 44, through the docking element 54 and to the atomizer 14a. The docking element 54 thus provides an interface to the selected supply line 44 aligned with the docking element 54.

The supply device 16 of this example further comprises a docking support 56, here exemplified as a docking plate. The docking support 56 is here rotatably connected to the base structure 40. In this example, the docking element 54 is fixed to the docking support 56. The supply device 16 of this example further comprises a docking actuator. The docking actuator is configured to drive the docking support 56 relative to the base structure 40.

The supply device 16 of this example further comprises a cleaning device 58. The cleaning device 58 is configured to clean the body 34 of the atomizer 14a. The cleaning device 58 of this example comprises a container 60. The container 60 is configured to sealingly receive the distal section 38 of the atomizer 14a.

The cleaning device 58 of this example further comprises an actuator 62. The actuator 62 is controlled by the supply control system 28. The actuator 62 is arranged to move the container 60 linearly relative to the base structure 40 (which is stationary). In this example, the container 60 is movable in a direction transverse to the rotation axis 50, here in a vertical direction. In FIG. 3, the container 60 is in a releasing position 64.

While the industrial robot 12 performs a painting operation, the switching device 42 rotates the rotatable disc 46 such that a supply line 44 with a new color is connected to the docking element 54. In this specific example, before rotation of the rotatable disc 46, the docking support 56 is moved away from the rotatable disc 46 to disconnect the docking element 54 from the previous supply line 44. The rotatable disc 46 is then rotated such that the new supply line 44 with the desired paint 24 becomes aligned with the docking element 54. The docking support 56 is then moved back towards the rotatable disc 46 to connect the docking element 54 to the new supply line 44.

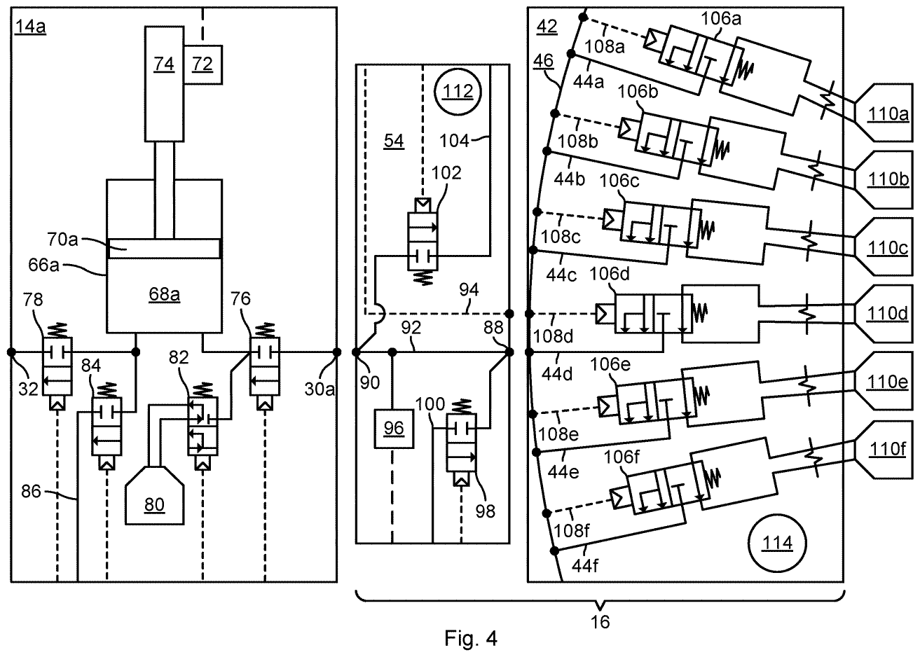

FIG. 4 schematically represents a block diagram of components of the atomizer 14a and the supply device 16. In FIG. 4, six supply lines 44a-44f can be seen. One, several or all of the supply lines 44a-44f may alternatively be referred to with reference numeral “44”.

The atomizer 14a comprises a tank 66a for the paint 24. Before each painting cycle, the tank 66a must be filled with a desired amount of paint 24. The tank 66a comprises a tank volume 68a and a piston 70a movable relative to the tank 66a to vary the tank volume 68a and to control the pressure of the paint 24 therein. The tank 66a can be brought in fluid communication with the inlet 30a for receiving paint 24 therefrom. The tank 66a can also be brought in fluid communication with the outlet 32 for applying paint 24 therethrough.

The atomizer 14a of this example further comprises an electric servomotor 72 and a transmission 74. The servomotor 72 is configured to move the piston 70a via the transmission 74 based on a position of the piston 70a. The servomotor 72 is controlled by the robot control system 22.

The atomizer 14a of this specific example further comprises an inlet valve 76. The inlet valve 76 is arranged to selectively open to allow a flow of paint 24 from the inlet 30a to the tank 66a. The inlet valve 76 of this example is a 2/2 valve pneumatically operated under control of the robot control system 22.

The atomizer 14a of this specific example further comprises an outlet valve 78. The outlet valve 78 is arranged to selectively open to allow a flow of paint 24 from the tank 66a to the outlet 32. The outlet valve 78 of this example is a 2/2 valve pneumatically operated under control of the robot control system 22.

The atomizer 14a of this specific example further comprises a cleaning medium source 80, a tank cleaning valve 82 and an atomizer dump valve 84. The cleaning medium source 80 contains pressurized cleaning medium. By opening the tank cleaning valve 82 and the atomizer dump valve 84, the cleaning medium can be supplied to the tank 66a and further through an atomizer dump line 86. In this example, the tank cleaning valve 82 is 3/2 valve and the atomizer dump valve 84 is a 2/2 valve, both pneumatically operated under control of the robot control system 22.

The docking element 54 comprises an internal port 88 and an external port 90. The internal port 88 can be connected to the selected supply line 44, here supply line 44d. The external port 90 can be connected to the inlet 30a. The docking element 54 further comprises a docking line 92 for conducting paint 24 from the internal port 88 to the external port 90. As illustrated, the docking line 92 is straight. The only flow path of paint 24 towards the tank 66a is from the internal port 88, through the docking line 92 and to the external port 90.

The docking element 54 has a small width and the docking line 92 therethrough is short, for example less than 30 mm. The short length of the docking line 92 enables its flow area to be slightly increased without a significant increase of paint waste. In this way, the flow through the docking element 54 can be increased and filling of the tank 66a can be made faster. The docking line 92 is shaped to minimize pressure drop and flow restriction. The docking element 54 of this specific example further comprises a docking control line 94, here exemplified as a pneumatic control line.

The docking element 54 of this specific example further comprises a pressure sensor 96. The pressure sensor 96 is configured to measure a pressure of the paint 24 inside the docking line 92. In this example, the pressure sensor 96 is configured to send a signal indicative of the pressure of the paint 24 to the supply control system 28.

The docking element 54 of this specific example further comprises an inlet cleaning valve 98. The inlet cleaning valve 98 is arranged to selectively open to allow a flow of cleaning medium through an inlet cleaning line 100 to the internal port 88. The inlet cleaning valve 98 of this example is a 2/2 valve pneumatically operated under control of the supply control system 28.

The docking element 54 of this specific example further comprises an outlet dump valve 102. The outlet dump valve 102 is arranged to selectively open to allow a flow of cleaning medium from the external port 90 through an outlet dump line 104. The outlet dump valve 102 of this example is a 2/2 valve pneumatically operated under control of the supply control system 28. As shown in FIG. 4, the supply device 16 is designed such that a direct connection can be made between the tank 66a and any of the supply lines 44a-44f. The supply device 16 of this specific example comprises one supply valve 106a-106f and one supply control line 108a-108f associated with each supply line 44a-44f. When connected to the internal port 88, the supply valves 106a-106f can be controlled to open to allow a flow of paint 24 from an associated paint source 110a-110f to the internal port 88. The supply valves 106a-106f are here controlled via the docking control line 94. The supply valves 106 a-106f of this example are 3/2 valves pneumatically operated under control of the robot control system 22. The paint sources 110a-110f may be factory supply lines.

In FIG. 4, the docking actuator 112 for driving the docking support 56 and the switching actuator 114 for rotating the rotatable disc 46 can be seen. Each of the docking actuator 112 and the switching actuator 114 is controlled by the supply control system 28.

As soon as a paint task is completed and the industrial robot 12 starts moving back to refill at the supply device 16, cleaning of the tank 66a starts. The cleaning of the tank 66a can thus start before the atomizer 14a is docked to the supply device 16. During cleaning of the tank 66a, the tank cleaning valve 82 and the atomizer dump valve 84 open to supply cleaning medium to the tank 66a and further to the atomizer dump line 86.

The atomizer 14a then docks to the supply device 16 such that the inlet 30a is connected to the external port 90. Regardless of which color should be filled to the tank 66a, the atomizer 14a moves to the same position for filling in this example.

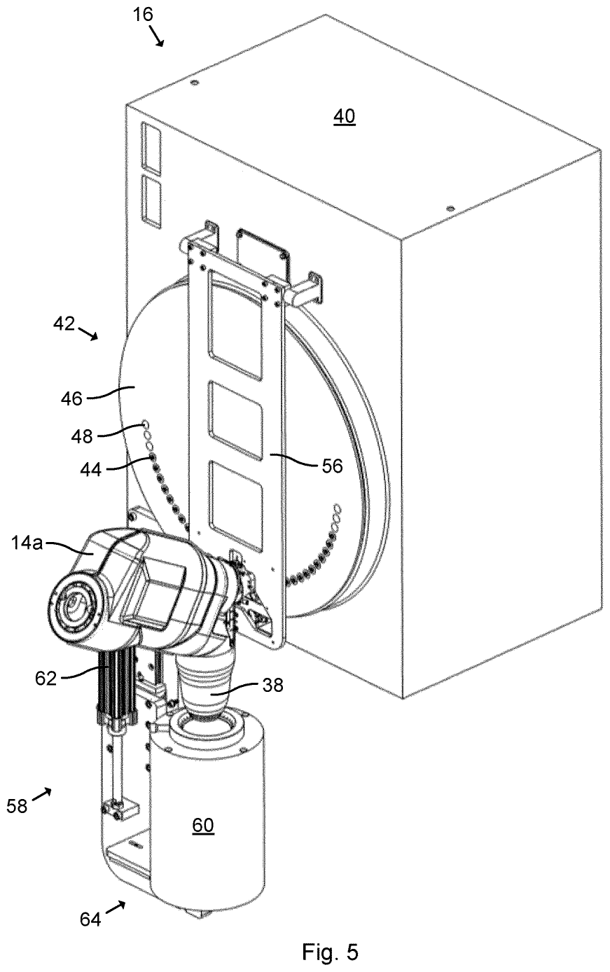

FIG. 5 schematically represents a perspective front view of the supply device 16 when the atomizer 14a is docked to the docking element 54. The supply device 16 now fills the tank 66a with the selected color, here from the supply line 44d. In this example, the supply valve 106d and the inlet valve 76 are then controlled to open such that the requested paint 24 is supplied from the supply line 44d, through the docking line 92 and into the tank 66a. Due to the short length of the docking line 92, the supply line 44d is connected almost directly to the inlet 30a. During filling of the tank 66a, the body 34 is simultaneously cleaned by the cleaning device 58, as described below.

Once the tank 66a has been filled with the selected paint 24, the supply valve 106d is closed. Cleaning of the docking element 54 may then be performed if needed. Since only the short docking line 92 may have to be cleaned, waste of paint 24 is minimized. The paint waste is also minimized for all colors.

In this example, the cleaning of the docking element 54 takes place while the atomizer 14a remains connected to the supply device 16. To effect cleaning of the docking element 54 in this example, the inlet cleaning valve 98 and the outlet dump valve 102 are controlled to open such that cleaning medium is supplied from the inlet cleaning line 100, through the docking line 92 and to the outlet dump line 104. In the supply device 16, the only waste of paint 24 is inside the docking element 54, which may have to be cleaned before a new paint 24 is supplied.

After cleaning of the docking element 54, the atomizer 14a is disconnected from the docking element 54 and the industrial robot 12 carrying the atomizer 14a departs for performing a next paint cycle. When the atomizer 14a is undocked from the docking element 54, the docking support 56 is moved by means of the docking actuator 112 such that the docking element 54 is disconnected from the supply line 44. The switching device 42 then rotates the rotatable disc 46 such that a next selected supply line 44 becomes aligned with the docking element 54. The docking support 56 is then moved back such that the internal port 88 becomes connected to the next selected supply line 44. The above steps may then be repeated for the next color.

The supply device 16 enables change of colors in a short time and with low waste. This is highly valuable since the filling in this example is performed during the non-productive time of the industrial robot 12.

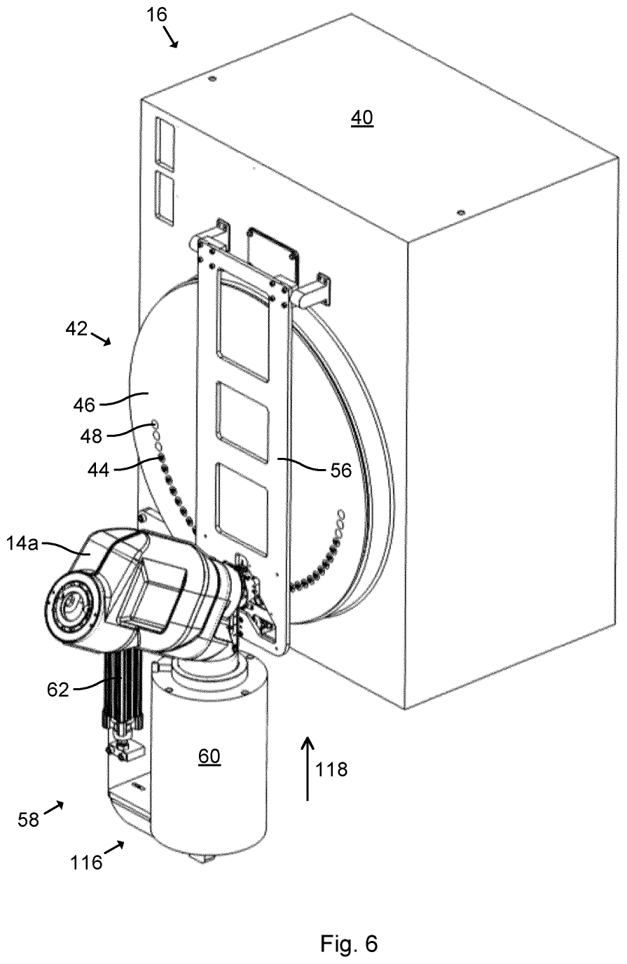

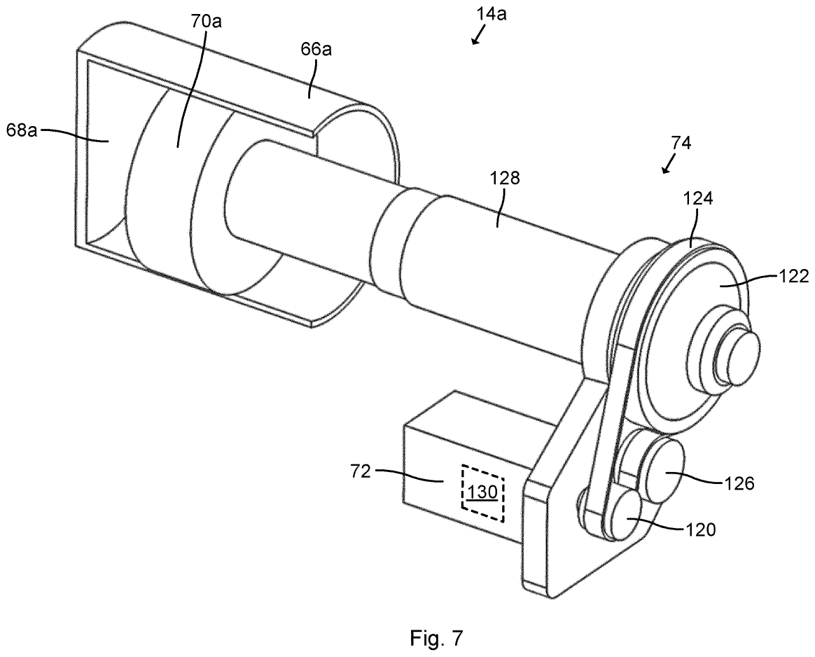

FIG. 6 schematically represents a perspective front view of the supply device 16 and the atomizer 14a when the atomizer 14a is docked to the docking element 54 for filling of the tank 66a. The container 60 has now moved linearly from the releasing position 64 to a cleaning position 116, as indicated with arrow 118. In the cleaning position 116, the cleaning device 58 cleans the body 34 while the atomizer 14a is docked to the docking element 54 for filling. The supply device 16 thereby enables cleaning of the body 34 without extending a downtime of the industrial robot 12.

In the cleaning position 116, the body 34 is sealingly received in the container 60. Cleaning medium is sprayed from the container 60 onto the body 34 to clean the body 34. During cleaning of the body 34, the tank cleaning valve 82 and the outlet valve 78 may be controlled to open while the atomizer dump valve 84 is controlled to close such that also the outlet 32 is cleaned while the body 34 is in the container 60.

Once the spraying of cleaning medium has ended, pressurized air is sprayed onto the body 34 to dry the same from cleaning medium at the same time as the container 60 moves back from the cleaning position 116 to the releasing position 64. At this time, the atomizer 14a may remain connected to the supply device 16 for filling. Due to the drying, it is ensured that no cleaning medium will drop from the atomizer 14a onto the object 26 during the next painting cycle. When the container 60 again adopts the releasing position 64, the atomizer 14a is free to undock from the supply device 16 without colliding with the container 60.

Without the cleaning device 58, the atomizer 14a would not be possible to clean until after completion of the filling when the atomizer 14a is undocked from the docking element 54. The cleaning device 58 thus enables significant time savings.

FIG. 7 schematically represents a perspective view of components of the atomizer 14a. As shown in FIG. 7, the transmission 74 of this specific example comprises a first pulley 120 and a second pulley 122. The first pulley 120 is here fixed to an output shaft of the servomotor 72. The second pulley 122 is larger than the first pulley 120. The transmission 74 further comprises a belt 124. Rotation of the first pulley 120 is transmitted by the belt 124 to a rotation of the second pulley 122. The transmission 74 further comprises a tension pulley 126 supporting the belt 124.

The transmission 74 of this example further comprises a translation mechanism 128, here exemplified as a translation screw. The translation mechanism 128 is arranged to transmit a rotation of the second pulley 122 to a linear movement of the piston 70a.

The atomizer 14a of this example further comprises an encoder 130.

The encoder 130 is in signal communication with the supply control system 28. The encoder 130 provides a signal indicative of a position of the piston 70a, here a position signal containing a value of an absolute position of the output shaft of the servomotor 72.

During filling of the tank 66a, the amount of paint 24 to be filled is controlled by the servomotor 72. In this example, the servomotor 72 is controlled based on the position signal and the pressure measured by the pressure sensor 96 inside the docking element 54, and seeks to control the pressure inside the tank 66a during filling and keep it constant at for example 1 bar.

The transmission 74 enables the servomotor 72 to stop at any time, even if the pressure of the paint 24 is 15 bar. The servomotor 72 and the transmission 74 can handle the full pressure of the supply line 44. The use of the servomotor 72 enables a very precise filling of the tank 66a and a consequential paint waste reduction.

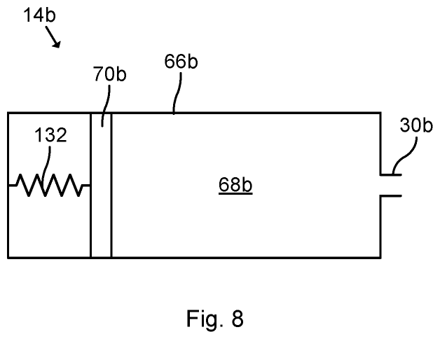

FIG. 8 schematically represents a side view of a further example of a coating medium apparatus, here exemplified as a cartridge 14b. The cartridge 14b of this specific example comprises an inlet 30b, a tank 66b, a tank volume 68b, a piston 70b for adjusting the tank volume 68b and a spring 132 forcing the piston 70b towards the inlet 30b. Similarly to the atomizer 14a, the cartridge 14b may be directly connected to a selected supply line 44 of the supply device 16. The cartridge 14b may optionally be used in the system 10. In this case, the dimensions of the docking line 92 can be significantly reduced since the cartridge 14b can be filled during the productive time, i.e. when the industrial robot 12 applies the paint 24.

The cartridge 14b containing the tank 66b may replace the tank 66a in the atomizer 14a, or in another type of atomizer. The cartridge 14b is thus a coating medium apparatus, but not a coating apparatus. The atomizer 14a on the other hand, is both a coating medium apparatus and a coating apparatus.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A supply device for supplying coating medium to a tank, the supply device comprising:
a docking element;
a plurality of supply lines; and
a switching device having a connection member to which each supply line is connected, the switching device being configured to move the connection member or the docking element in order to connect a selected supply line to the docking element for supply of coating medium from the selected supply line through the docking element.

2. The supply device according to claim 1, wherein the connection member is rotatable in order to connect the selected supply line to the docking element.

3. The supply device according to claim 1, wherein the docking element comprises an internal port to which each supply line can be selectively connected, and an external port to which an inlet of a coating medium apparatus can be connected, wherein the docking element is configured to conduct coating medium from the internal port to the external port.

4. The supply device according to claim 1, further comprising a cleaning device arranged to clean an exterior body of a coating medium apparatus comprising the tank while the coating medium apparatus is connected to the docking element.

5. The supply device according to claim 4, wherein the cleaning device comprises a container arranged to at least partly receive the body and to supply cleaning medium onto the body.

6. The supply device according to claim 5, wherein the supply device is configured to move the container relative to the docking element between a releasing position where the body is cleared form the container, and a cleaning position where the body is at least partly received in the container, while the coating medium apparatus is connected to the docking element.

7. The supply device according to claim 6, wherein the container is linearly movable between the releasing position and the cleaning position.

8. A coating medium apparatus for applying coating medium to an object, the coating medium apparatus comprising:
an inlet for receiving coating medium;
a tank having a tank volume for receiving coating medium from the inlet;
a piston movable relative to the tank to vary the tank volume; and
a servomotor configured to control movements of the piston based on a position of the piston.

9. The coating medium apparatus according to claim 8, further comprising an outlet for applying coating medium to the object, wherein the tank is arranged to supply coating medium to the outlet.

10. The coating medium apparatus according to claim 8 wherein the servomotor is configured to control movements of the piston based on a pressure of the coating medium.

11. The coating medium apparatus according claim 8, wherein the servomotor is arranged to withstand a pressure of the coating medium of at least 2 bar.

12. A coating system comprising:
a supply device having
a plurality of supply lines, and
a switching device having a connection member to which each supply line is connected, the switching device being configured to move the connection member or the docking element in order to connect a selected supply line to the docking element for supply of coating medium from the selected supply line through the docking element;
a coating medium apparatus having an inlet configured to be connected to the docking element.

13. A method of supplying coating medium to a tank, the method comprising:
providing a supply device having a docking element, a plurality of supply lines and a switching device having a connection member to which each supply line is connected;
providing a coating medium apparatus comprising an inlet and the tank;
connecting the inlet to the docking element and receiving a first coating medium in the tank from a first supply line through the docking element;
disconnecting the inlet from the docking element; and
moving the connection member or the docking element in order to connect a second supply line to the docking element.

14. The method according to claim 13, further comprising:
providing a cleaning device; and
cleaning an exterior body of the coating medium apparatus by means of the cleaning device while the inlet is connected to the docking element.

15. The method according to claim 14, wherein the cleaning device comprises a container, and wherein the cleaning includes:
moving the container relative to the body such that the body is at least partly received in the container; and
supplying cleaning medium onto the body.

16. The supply device according to claim 2, wherein the docking element comprises an internal port to which each supply line can be selectively connected, and an external port to which an inlet of a coating medium apparatus can be connected, wherein the docking element is configured to conduct coating medium from the internal port to the external port.

17. The supply device according to claim 2, further comprising a cleaning device arranged to clean an exterior body of a coating medium apparatus comprising the tank while the coating medium apparatus is connected to the docking element.

18. The coating medium apparatus according to claim 9, wherein the servomotor is configured to control movements of the piston based on a pressure of the coating medium.

19. The coating medium apparatus according claim 9, wherein the servomotor is arranged to withstand a pressure of the coating medium of at least 2 bar.
